(19) United States
(12) Patent Application Publication
(10) Pub. No.: US 2014/0375614 A1
(43) Pub. Date: Dec. 25, 2014

(54) ACTIVE MATRIX DISPLAY, SCANNING DRIVEN CIRCUIT AND THE METHOD THEREOF

(71) Applicant: Shenzhen China Star Optoelectronics Technology Co. Ltd., Shenzhen (DE)

(72) Inventors: Dongsheng Guo, Shenzhen (CN); Hongjiang Qin, Shenzhen (CN)

(73) Assignee: Shenzhen China Star Optoelectronics Technology Co., Ltd., Shenzhen, Guangdong (CN)

(21) Appl. No.: 13/985,290

(22) PCT Filed: Jun. 28, 2013
(86) PCT No.: PCT/CN2013/078269

§ 371 Date: Aug. 14, 2013

(30) Foreign Application Priority Data
Jun. 20, 2013 (CN) 201310247245X

(51) Int. Cl. G09G 5/18

(52) U.S. Cl. CPC G09G 5/18
USPC 345/204

(57) ABSTRACT

An active matrix display, and the scanning driven circuit and the scanning driven method thereof are disclosed. The scanning driven circuit includes a delaying module. An input end of the delaying module receives input signals integrated by initial clock voltage pulse (CKV) signals and start voltage pulse (STV) signals. The input signals are delayed by a first delayed portion and a second delayed portion such that a first output of the delaying module outputs output enable (OE) signals and a second output of the delaying module outputs the delayed CKV signals. In this way, the number of the transmission lines is decreased, and the number of the output pins of the timing control chips and that of the input pins of the scanning driven chips are also decreased.

### BACKGROUND OF THE INVENTION

1. Field of the Invention

The present disclosure relates to liquid crystal display (LCD) technology, and more particularly to an active matrix display and the scanning driven circuit and method thereof

2. Discussion of the Related Art

Currently, scanning driven chips have three control signals for switching the on/off state of each row of the active matrix display. The control signals are respectively start voltage pulse (STV) signals, clock voltage pulse (CKV) signals, and output enable (OE) signals. FIG. 1 is a waveform diagram of conventional scanning driven signals. As shown, the STV signals control the initial state of the first row. The CKV signals control the on/off frequency of each row. Upon detecting the rising edge of the STV signals, the OE signals are arranged between the on and off state of each rows. The OE signals compress the output voltage during the high level period. The OE signals control the switching time of the on/off state of each rows such that the on/off state are interleaved. Thus, the scanning signals are prevented from being delayed due to parasitic capacitance.

The above three control signals are generated by the timing control chips, and are transmitted to the glass substrate by the soft circuit hoard on the data driving chips. The control signals have to be further transmitted to the scanning driven chips by three transmission lines on the glass substrate. As such, the design of the active matrix display, especially for the narrow bezel one, is difficult. It can be understood that while a plurality of transmission lines are arranged on the soft circuit board, the bonding difficulty is increased. Moreover, a plurality of output pins of corresponding timing control chips and input pins of corresponding scanning driven chips are needed, which result in additional cost.

### SUMMARY

The object of the invention is to provide an active matrix display, the scanning driven circuit and the method thereof to reduce the number of the transmission lines.

In one aspect, a scanning driven circuit for an active matrix display includes: a delaying module, an input end of the delaying module receives input signals to be delayed twice, the input signals are integrated by initial clock voltage pulse (CKV) signals and start voltage pulse (STV) signals, a first output of the delaying module outputs output enable (OE) signals after the input signals pass a first delayed portion, a second output of the delaying module outputs the delayed CKV signals after the input signals pass a second delayed portion, and the OE signals and the delayed CKV signals are output to scanning lines of the active matrix display.

Wherein a duration of the STV signals is t1, the duration of the initial CKV signals is t2, a time period of the initial CKV signals is T, and wherein t1, t2, and T satisfy an equation of: t2<t1<t2+T.

Wherein t1, t2, and T satisfy the equation of: t2<t1<T

Wherein t1, t2, and T satisfy the equation of: T≦t1≦t2+T.

Wherein the delaying module includes 2n first inverters and 2m second inverter, the input signals pass through the 2n first inverters to output the OE signals by the first output, the input signals pass through the 2n first inverters and the 2m second inverters to output the delayed CKV signals by the second output, and wherein n and m are natural numbers.

Wherein a delayed duration of each of the first inverters is Δtn, and the delayed duration of each of the first inverters is Δtm, and Δtn, Δtm, t1 and t2 satisfy the equations of t2<(2n*Δtn+2m*Δtm)<t1; and 0<2m*Δtm<t2.

In another aspect, an active matrix display includes: a timing control circuit generating initial CKV signals and STV signals; a signal integration circuit, an input end of the signal integration circuit couples an output end of the timing control circuit to integrate the initial CKV and the STV and to generate input signals; a scanning driven circuit comprising a delaying module, an input end of the delaying module couples an output end of the signal integration circuit to receive the input signals, the delaying module delays the input signals twice, and wherein a first output of the delaying module outputs OE signals after the input signals pass a first delayed portion, a second output of the delaying module outputs the delayed CKV signals after the input signals pass a second delayed portion, and the OE signals and the delayed CKV signals are output to scanning lines of the active matrix display.

Wherein a duration of the STV signals is t1, the duration of the initial CKV signals is t2, a time period of the initial CKV signals is T, and wherein t1, t2, and T satisfy an equation of: t2<t1<t2+T.

Wherein t1, t2, and T satisfy the equation of: t2<t1<T.

Wherein t1, t2, and T satisfy the equation of: T≦t1≦t2+T.

Wherein a delaying module includes 2n first inverters and 2m second inverter, the input signals pass through the 2n first inverters to output the OE signals by the first output, the input signals pass through the 2n first inverters and the 2m second inverters to output the delayed CKV signals by the second output, and wherein n and m are natural numbers.

Wherein the delayed duration of each of the first inverters is Δtn, and the delayed duration of each of the first inverters is Δtm, and Δtn, Δtm, t1 and t2 satisfy the equations of: t2<(2n*Δtn+2m*Δtm)<t1; and 0<2m*Δtm<t2.

Wherein the active matrix display further includes at least one scanning driven chip, and the delaying module is arranged within the scanning driven chip.

In another aspect, a scanning driven method of an active matrix display with a tuning control circuit and a scanning driven circuit includes: overlapping initial CKV signals and STV signals generated by the timing control circuit to be input signals of the scanning driven circuit; delaying the input signals twice by a delaying module of the scanning driven circuit, a first output of the delaying module outputs OE signals after the input signals pass a first delayed portion, and a second output of the delaying module outputs the delayed CKV signals after the input signals pass the second delayed portion, and outputting the OE signals and the delayed CKV signals to the scanning lines of the active matrix display.

Wherein a duration of the STV signals is t1, the duration of the initial CKV signals is t2, a time period of the initial CKV signals is T and wherein t1, t2, and T satisfy an equation of t2<t1<t2+T.

Wherein t1, t2, and T satisfy the equation of: t2<t1<T.

Wherein t1, t2, and T satisfy the equation of: T≦t1≦t2+T.

Wherein the delaying module includes 2n first inverters and 2m second inverter, the input signals pass through the 2n first inverters to output the OE signals by the first output, the input signals pass through the 2n first inverters and the 2m second inverters to output the delayed CKV signals by the second output, and wherein n and m are natural numbers.

Wherein a delayed duration of each of the first inverters is Δtn, and the delayed duration of each of the first inverters is Δtm, and Δtn, Δtm, t1 and t2 satisfy the equations of: t2<(2n*Δtn+2m*Δtm)<t1; and 0<2m*Δtm<t2.

In view of the above, the scanning driven circuit includes a delaying module. An input end of the delaying module receives input signals integrated by initial clock voltage pulse (CKV) signals and start voltage pulse (STV) signals. The input signals are delayed by a first delayed portion and a second delayed portion such that a first output of the delaying module outputs output enable (OE) signals and a second output of the delaying module outputs the delayed CKV signals. The OE signals and the delayed CKV signals are output to scanning lines of the active matrix display. Only one corresponding transmission line is needed to transmit the input signals. The number of the transmission lines is decreased, which contributes to the narrow bezel design. On the other hand, the gap between the transmission lines is increased such that the bonding difficulty is reduced. Furthermore, the number of the output pins of the timing control chips and that of the input pins of the scanning driven chips are decreased such that the cost is reduced.

### BRIEF DESCRIPTION OF THE DRAWINGS

FIG. 1 is a waveform diagram of conventional scanning driven signals.

FIG. 2 is a schematic view of the active matrix display in accordance with one embodiment.

FIG. 3 shows the initial CKV signals and STV signals that satisfy one condition in accordance with one embodiment.

FIG. 4 is a schematic view of the scanning driven circuit of FIG. 2.

FIG. 5 is a simulated waveform diagram showing the delayed input signals.

FIG. 6 is a waveform diagram of the scanning driven signals of the active matrix display in accordance with one embodiment.

FIG. 7 shows the initial CKV signals and STV signals that satisfy one condition in accordance with another embodiment.

FIG. 8 is a waveform diagram of the scanning driven signals of the active matrix display in accordance with another embodiment.

FIG. 9 is a flowchart illustrating the scanning driven method of the active matrix display in accordance with one embodiment.

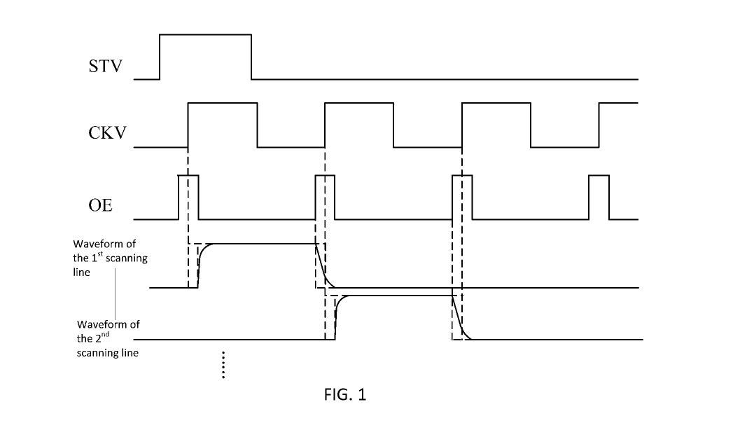

### DETAILED DESCRIPTION OF THE EMBODIMENTS

Embodiments of the invention will now be described more fully hereinafter with reference to the accompanying drawings, in which embodiments of the invention are shown.

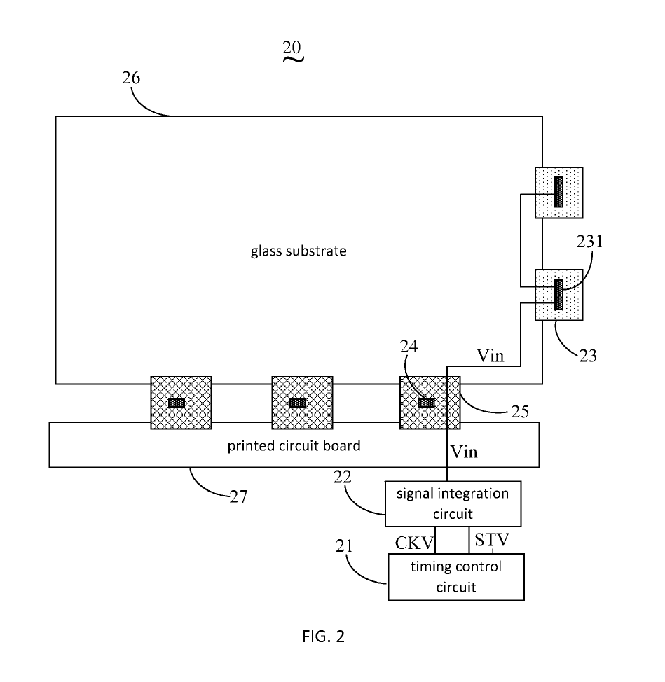

FIG. 2 is a schematic view of the active matrix display in accordance with one embodiment. The active matrix display 20 includes a timing control circuit 21, a signal integration circuit 22, and a scanning driven circuit 23.

The timing control circuit 21 generates initial CKV signals and STV signals.

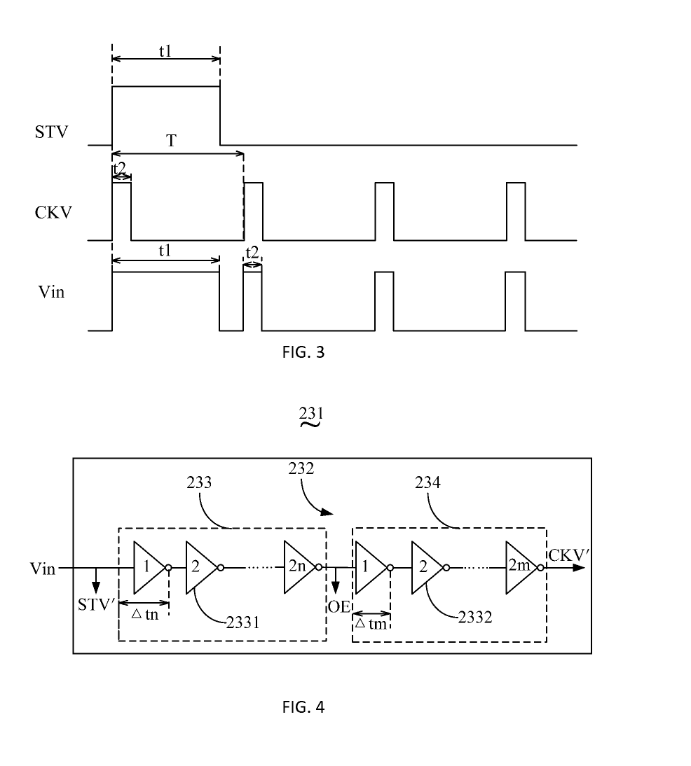

An input end of the signal integration circuit 22 couples an output end of the timing control circuit 21 to overlap the initial CKV signals and STV signals such that the input signals Vin is generated. FIG. 3 shows the initial CKV signals and STV signals that satisfy one condition in accordance with one embodiment. As shown, the duration of the initial STV signals is t1, the duration of the initial CKV signals is t2, and the time period of the initial CKV signals is T. In one embodiment, t1, t2, and T satisfy condition (1) “t2<t1<t2+T.”

The scanning driven circuit 23 includes at least one scanning driven chip 231 with a delaying module 232 (also referring to FIG. 4).

FIG. 4 is a schematic view of the delaying module 232 in accordance with one embodiment. As shown, the delaying module 232 is arranged within the scanning driven chip 231. The input signals Vin are input to the input end of the delaying module 232, and then are delayed twice by a first delayed portion 233 and by a second delayed portion 234. After the input signals pass the first delayed portion 233, a first output of the delaying module 232 outputs OE signals. After the input signals pass the second delayed portion 234, a second output of the delaying module 232 outputs the delayed CKV′signals. The OE signals and the delayed CKV signals arc output to the scanning lines of the active matrix display 20.

Specifically, the delaying module 232 includes 2n first inverters 2331 and 2m second inverter 2332. The input signals Vin are input to the input end of the delaying module 232 to operate as the STV signals of the scanning driven chip 231 so as to trigger at least one register of the first row. After being input to the delaying module 232, the input signals Vin pass through the 2n first inverters 2331 to output the OE signals by the first output. The input signals Vin then pass through the 2m second inverters 2332 to output the delayed CKV′ signals by the second output. In the embodiment, n and m are natural numbers.

FIG. 5 is a simulated waveform diagram showing the delayed input signals. In the embodiment, the delayed duration of each of the first inverters 2331 is Δtn, the delayed duration of each of the first inverters 2332 is Δtm, and Δtn, Δtm, t1 and t2 satisfy the condition (2) and (3).

Regarding condition (2), the equation “t2<(2n*Δtn+2m*Δtm)<t1” is satisfied such that the STV′ signals are only applied to the registers in the first row. Specifically, the equation “(2n*Δtn+2m*Δtm)<t1” results in that only the shift registers in the first row can be triggered, and the equation “t2<(2n*Δtn+2m*Δtm)” results in that the shift registers in the first row can be only triggered once.

Regarding condition (3), the equation “0<2m*Δtm<t2” is satisfied such that the rising edge of the delayed CKV′ signals are at high level of the OE signals.

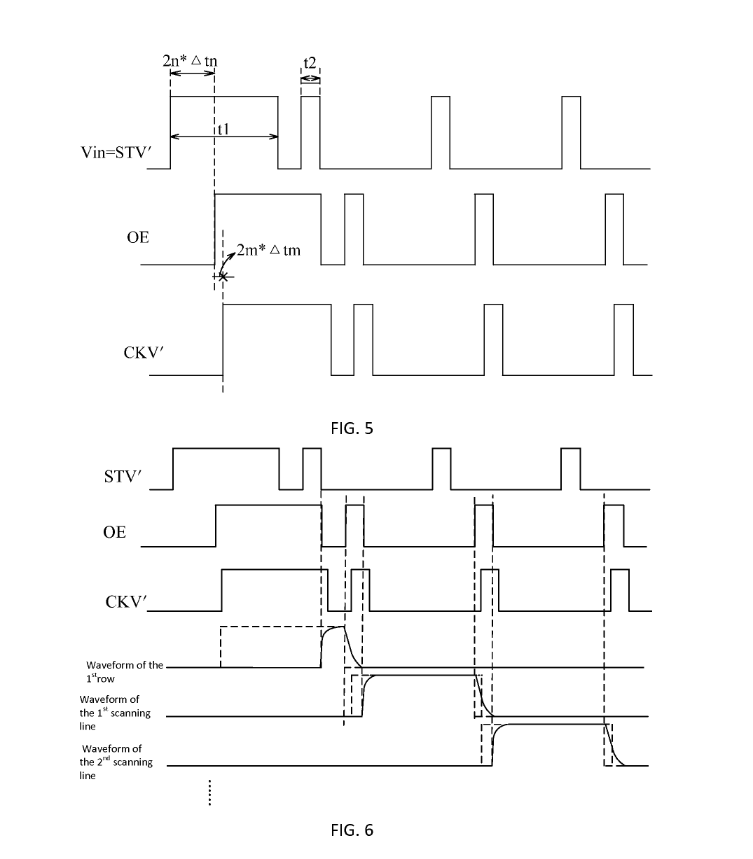

FIG. 6 is a waveform diagram of the scanning driven signals of the active matrix display in accordance with one embodiment. As shown, the STV′ signals, the OE signals, and the delayed CKV′ signals are triggered during the high level period. When the OE signals is at high level, the voltage level of all of the channels are forcedly compressed. When the STV′ signals and the delayed CKV′ signals are at high level, as the OE signals are at high level, the output voltage is forcedly compressed. Thus, the waveform of the first row is at low level. When the OE signals are at low level and the delayed CKV′ signals are at high level, the high level signals are output to trigger the registers in the first row. When the OE signals transit from low level to high level, the output voltage of the STV′ signals are compressed. When the output level of the STV′ signals transit from the high level to the low level, the delayed CKV signals transit from the low level to the high level. During the above process, the OE signals transit from the high level to the low level, and the next row is triggered so as to output the high level. In the embodiment, as the rising edge of the delayed CKV′ signals is during the high level period of the OE signals, the voltage level of the current row is compressed before the registers in the next row are triggered. Thus, the switching time of the on/off state of each row are interleaved.

It can be referred from FIG. 6 that the waveform of the first row is different from that of other rows such that the waveform of the first row has to be omitted. In the embodiment, the output of the registers in the first row, which corresponds to the STV′ signals, is set aside. Thus, the needed data can be output after the time period T.

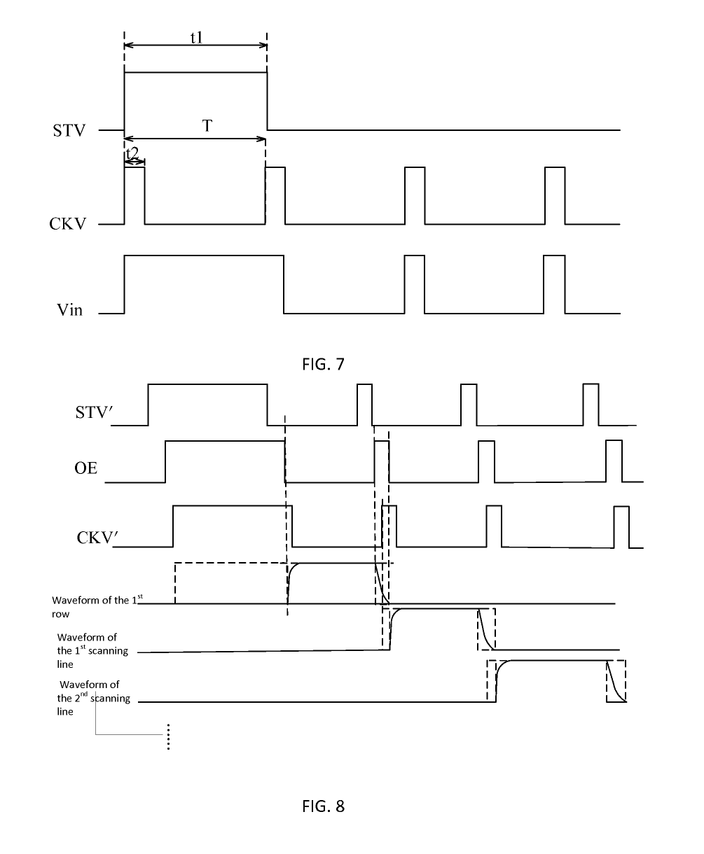

In other embodiments, when the above conditions (2) and (3) remain and the t1 t2, and T satisfy the equation “T≦t1≦t2+T”, the integration of the initial CKV signals and the STV signals to obtain the input signals Vin is as shown in FIG. 7. Similarly, the output of the first and the second row are also set aside when the input signals Vin operates as the STV′ signals of the scanning driven chip 231. As shown in FIG. 8, the needed data can be output after the time period 2T.

In view of the above, the initial CKV signals and the STV signals, which are generated by the timing control circuit 21 are integrated to be one input signals Vin and then transmitted to the scanning driven chip 231. Only one corresponding transmission line is needed to transmit the input signals Vin. Referring to FIG. 2, the active matrix display 20 further includes at least one data driven chip 24, the soft circuit board 25, the glass substrate 26, and a printed circuit board 27. The input signals Vin are transmitted from the printed circuit board 27 to the soft circuit board 25 of the data driven chip 24, and then are transmitted from the transmission lines on the soft circuit board 25 to the glass substrate 26. Afterward, the input signals yin are transmitted by one transmission line on the glass substrate 26 to the scanning driven chip 231.

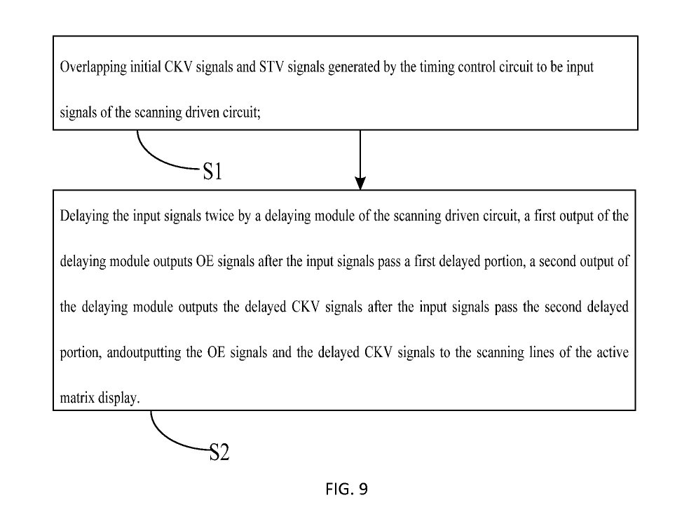

FIG. 9 is a flowchart illustrating the scanning driven method of the active matrix display in accordance with one embodiment. The method includes the following steps. In step S1, the initial CKV signals and STV signals generated by the timing control circuit are overlapped to be the input signals of the scanning driven circuit. The time period of the initial CKV signals is T, the duration of the initial STV signals is t1, the duration of the initial CKV signals is t2, and t1, t2, and T satisfy condition (1) “t2<t1 <t2+T” FIG. 3 shows the overlapping process when t2<t1<T, and FIG. 7 shows the overlapping process when T<t1<t2+T.

In step S2, the scanning driven circuit includes a delaying module. The input end of the delaying module receives the input signals to be delayed twice. The first output of the delaying module outputs OE signals after the input signals pass the first delayed portion. The second output of the delaying module outputs the delayed CKV′ signals after the input signals pass the second delayed portion. The OE signals and the delayed CKV′ signals are output to the scanning lines of the active matrix display. The delaying module includes 2n first inverters and 2m second inverter. The input signals operate as the STV′ signals of the scanning driven chip. The input signals pass through the 2n first inverters and the 2m second inverters, the delayed CKV′ signals are output from the second output, and n and m are natural numbers.

In the embodiment, the delayed duration of each of the first inverters is Δtn, and the delayed duration of each of the first inverters is Δtm. The equation “t2<(2n*Δtn+2m*Δtm)<t1” is satisfied such that the STV′ signals are only applied to the registers in the first row. Specifically, the equation “(2n*Δtn+2m*Δtm)<t1” results in that only the shift registers in the first row can be triggered, and the equation “t2<(2n*Δtn+2m*Δtm)” results in that the shift registers in the first row can be only triggered once. The equation “0<2m*Δtm<t2” is satisfied such that the rising edge of the delayed CKV′ signals are at high level of the OE signals. FIG. 6 shows the output waveform of the first row when t2<t1<T. FIG. 8 shows the output waveform of the first row when T≦t1≦t2+T.

In view of the above, the initial CKV signals and the STV signals, which are generated by the timing control circuit, are integrated to be one input signals and then transmitted to the scanning driven chip. The input signals are input to the input end of the delaying module of the scanning driven chips. The delaying module further performs two delayed portions on the input signals. After the input signals pass the first delayed portion, the first output of the delaying module outputs OE signals. After the input signals pass the second delayed portion, the second output of the delaying module outputs the delayed CKV′ signals. The OE signals and the delayed CKV′ signals are output to the scanning lines of the active matrix display. With the above configuration, the number of the transmission lines is decreased, which contributes to the narrow bezel design. On the other hand, the gap between the transmission lines is increased such that the bonding difficulty is reduced. Furthermore, the number of the output pins of the timing control chips and that of the input pins of the scanning driven chips are decreased such that the cost is reduced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A scanning driven circuit for an active matrix display, comprising:
a delaying module, an input end of the delaying module receives input signals to be delayed twice, the input signals are integrated by initial clock voltage pulse (CKV) signals and start voltage pulse (STV) signals, a first output of the delaying module outputs output enable (OE) signals after the input signals pass a first delayed portion, a second output of the delaying module outputs the delayed CKV signals after the input signals pass a second delayed portion, and the OE signals and the delayed CKV signals are output to scanning lines of the active matrix display.

2. The scanning driven circuit as claimed in claim 1, wherein a duration of the STV signals is t1, the duration of the initial CKV signals is t2, a time period of the initial CKV signals is T, and wherein t1, t2, and T satisfy an equation of: t2<t1<t2+T.

3. The scanning driven circuit as claimed in claim 2, wherein t1, t2, and T satisfy the equation of: t2<t1<T.

4. The scanning driven circuit as claimed in claim 2, wherein t1, t2, and T satisfy the equation of: T≦t1≦t2+T.

5. The scanning driven circuit as claimed in claim 2, wherein the delaying module comprises 2n first inverters and 2m second inverter, the input signals pass through the 2n first inverters to output the OE signals by the first output, the input signals pass through the 2n first inverters and the 2m second inverters to output the delayed CKV signals by the second output, and wherein n and m are natural numbers.

6. The scanning driven circuit as claimed in claim 5, wherein a delayed duration of each of the first inverters is Δtn, and the delayed duration of each of the first inverters is Δtm, and Δtn. Δtm, t1 and t2 satisfy the equations of:
t2<(2n*Δtn+2m*Δtm)<t1;
and
0<2m*Δtm<t2.

7. An active matrix display, comprising:
a timing control circuit generating initial CKV signals and STV signals;
a signal integration circuit, an input end of the signal integration circuit couples an output end of the timing control circuit to integrate the initial CKV and the STV and to generate input signals;
a scanning driven circuit comprising a delaying module, an input end of the delaying module couples an output end of the signal integration circuit to receive the input signals, the delaying module delays the input signals twice, and wherein a first output of the delaying module outputs OE signals after the input signals pass a first delayed portion, a second output of the delaying module outputs the delayed CKV signals after the input signals pass a second delayed portion, and the OE signals and the delayed CKV signals are output to scanning lines of the active matrix display.

8. The active matrix display as claimed in claim 7, wherein a duration of the STV signals is the duration of the initial CKV signals is t2, a time period of the initial CKV signals is T, and wherein t1, t2, and T satisfy an equation of t2<t1<t2+T.

9. The active matrix display as claimed in claim 8, wherein t1, t2, and T satisfy the equation of: t2≦t1≦t2+T.

10. The active matrix display as claimed in claim 8, wherein t1, t2, and T satisfy the equation of T≦t1≦t2+T.

11. The active matrix display as claimed in claim 8, wherein a delaying module comprises 2n first inverters and 2m second inverter, the input signals pass through the 2n first inverters to output the OE signals by the first output, the input signals pass through the 2n first inverters and the 2m second inverters to output the delayed CKV signals by the second output, and wherein n and m are natural numbers.

12. The active matrix display as claimed in claim 11, wherein the delayed duration of each of the first inverters is Δtn, and the delayed duration of each of the first inverters is Δtm, and Δtn, Δtm, t1 and t2 satisfy the equations of:
t2<(2n*Δtn+2m*Δtm)<t1;
and
0<2m*Δtm<t2.

13. The active matrix display as claimed in claim 7, further comprises at least one scanning driven chip, and the delaying module is arranged within the scanning driven chip.

14. A scanning driven method of an active matrix display, the active matrix display comprises a timing control circuit and a scanning driven circuit, the method comprising:
overlapping initial CKV signals and STV signals generated by the timing control circuit to be input signals of the scanning driven circuit: and
delaying the input signals twice by a delaying module of the scanning driven circuit, a first output of the delaying module outputs OE signals after the input signals pass a first delayed portion, a second output of the delaying module outputs the delayed CKV signals after the input signals pass the second delayed portion, and outputting the OE signals and the delayed CKV signals to the scanning lines of the active matrix display.

15. The scanning driven method as claimed in claim 14, wherein a duration of the STV signals is t1, the duration of the initial CKV signals is t2, a time period of the initial CKV signals is T, and wherein t1, t2, and T satisfy an equation of t2<t1<t2+T.

16. The scanning driven method as claimed in claim 15, wherein t1, t2, and T satisfy the equation of: t2<t1<T.

17. The scanning driven method as claimed in claim 15, wherein t1, t2, and T satisfy the equation of T≦t1≦t2+T.

18. The scanning driven method as claimed in claim 15, wherein the delaying module comprises 2n first inverters and 2m second inverter, the input signals pass through the 2n first inverters to output the OE signals by the first output, the input signals pass through the 2n first inverters and the 2m second inverters to output the delayed CKV signals by the second output, and wherein n and m are natural numbers.

19. The scanning driven method as claimed in claim 18, wherein a delayed duration of each of the first inverters is Δtn, and the delayed duration of each of the first inverters is Δtm, and Δtn, Δtm, t1 and t2 satisfy the equations of:
t2<(2n*Δtn+2m*Δtm)<t1;
and
0<2m*Δtm<t2.
